(19) United States
(12) Patent Application Publication
(10) Pub. No.: US 2004/0156998 A1
(43) Pub. Date: Aug. 12, 2004

(54) Method for preventing light guide plate from being distorted

(76) Inventor: Chang-Chih Sung, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/658,813

(22) Filed: Sep. 8, 2003

(30) Foreign Application Priority Data
Dec. 20, 2002 (TW) 91136965

(51) Int. Cl. B05D 1/02

(52) U.S. Cl. 427/421.1

(57) ABSTRACT

A method for preventing a light guide plate from being distorted contains the following steps: providing a light guide plate (10) having two surfaces (12, 14); attaching protective films (20) on the two surfaces before processing; removing the films and forming a polymer coating (30) on the surface of the light guide plate which is not to be processed immediately before processing, the polymer coating being formed on the surface before further steps of processing. Before processing, the light guide plate is protected by the protective films, which isolate the light guide plate from moisture in the air. During processing, the light guide plate is protected by the polymer coating formed on the surface of the light guide plate, which is not to be processed, so that the light guide plate is prevented from distorting due to moisture absorption in the air. Therefore, the quality of the product is improved.

### BACKGROUND OF THE INVENTION

1. Field of the Invention

The present invention relates to a light guide plate used in a backlight module for a liquid crystal display, and more particularly to a method for preventing a light guide plate from being distorted.

2. Description of Prior Art

Generally, a liquid crystal display device includes a liquid crystal panel having two substrates and a liquid crystal inserted therebetween, and a backlight module disposed under the liquid crystal panel.

A conventional backlight module comprises a light guide plate, a light source attached to at least one edge of the light guide plate, a reflecting sheet disposed at a bottom surface of the light guide plate, a diffusing sheet disposed on a top surface of the light guide plate, and a light condenser disposed on the diffusing sheet. The light guide plate is a critical element in the backlight module, and distribute light from a light source uniformly over the surface of the liquid crystal panel.

Generally, a light guide plate is substantially a rectangular plate comprising two main surfaces and four thin side surfaces, and is made of polymer resin, wherein polymethyl methacrylate is widely used. However, when the light guide plate is exposed in air, polymethyl methacrylate is prone to be distorted due to moisture absorption. Because the four side surfaces are thinner and smaller than the two main surfaces of the light guide plate, the distortion of the light guide plate are mostly due to moisture absorption of the two main surfaces. To solve the above described problem, skilled people in the art usually attach plastic protective films on the two main surfaces of the light guide plate, thereby isolating the light guide plate from moisture in the air before processing the light guide plate. However, when processing the light guide plate, such as forming a dot pattern or a v-shaped groove pattern on a main surface of the light guide plate, the protective films must be removed, in other words, another main surface of the light guide plate which is not to be processed is completely exposed to the air. This leads to visible distortion of the light guide plate due to moisture absorbed during the processing.

### SUMMARY OF THE INVENTION

In view of the above-described drawback, an object of the present invention is to provide a method for preventing a light guide plate from being distorted.

In order to achieve the object set out above, a method for preventing a light guide plate from being distorted in accordance with the present invention comprises the following steps: providing a light guide plate having two surfaces; attaching protective films on the two surfaces of the light guide plate before processing of the light guide plate; removing the protective films from the surfaces immediately before processing; and forming a polymer coating on one of the surfaces which is not to be processed after removing the protective films, the polymer coating being formed on the surface before further steps of processing. Because the light guide plate is protected by the protective films before processing, the light guide plate is isolated from moisture in the air. During processing, the light guide plate is protected by the polymer coating formed on the surface of the light guide plate which is not to be processed. This prevents the light guide plate from becoming distorted due to moisture absorption from the air. Therefore, the quality of the product is improved.

Other objects, advantages and novel features of the present invention will become more apparent from the following detailed description when taken in conjunction with the accompanying drawings, in which:

### BRIEF DESCRIPTION OF THE DRAWINGS

FIG. 1 is a flowchart of the preferred method for preventing a light guide plate from being distorted, according to the present invention;

FIG. 2 is a side view of the light guide plate after attaching protective films on top and bottom surfaces of the light plate according to the preferred method; and

FIG. 3 is a side view of the light guide plate when processing the light guide plate according to the preferred method, showing a polymer coating formed on a surface which is not to be processed.

### DETAILED DESCRIPTION OF PREFERRED EMBODIMENTS OF THE INVENTION

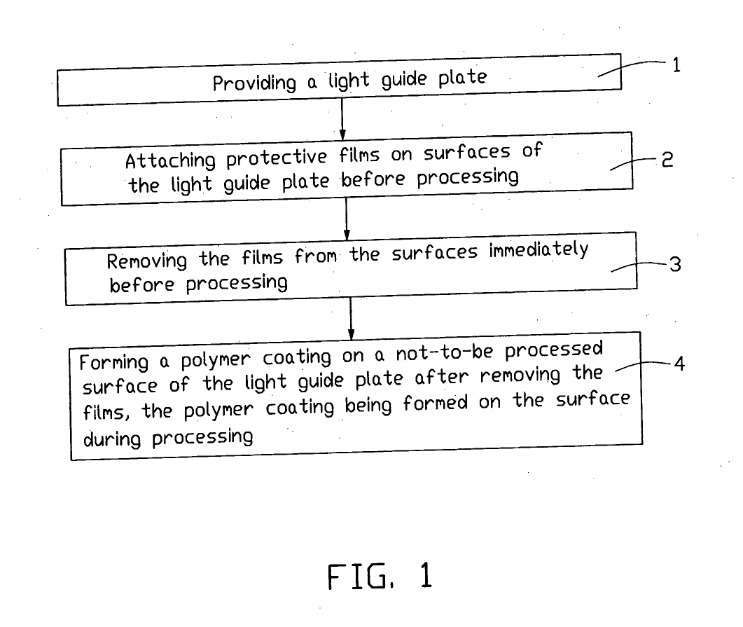

The preferred method for preventing a light guide plate from being distorted according to the present invention will be described with reference to the flowchart of FIG. 1.

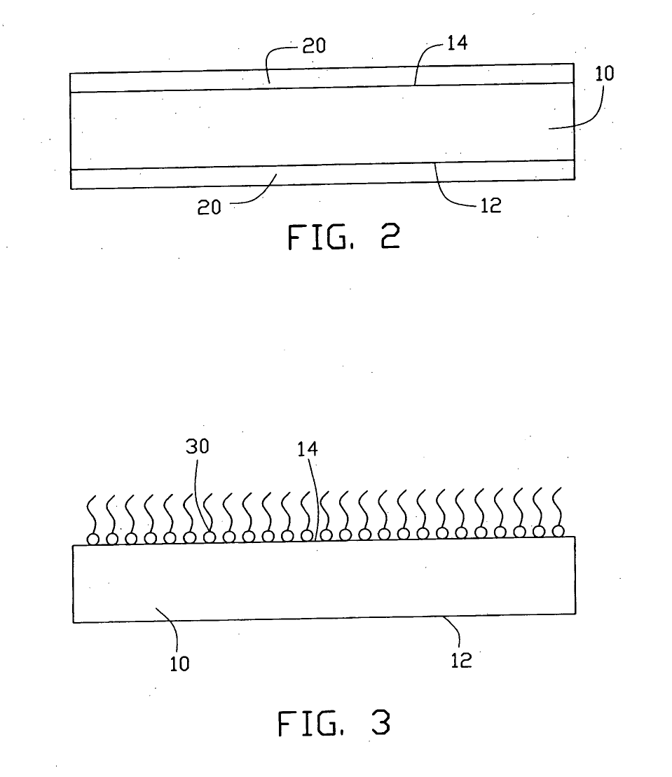

Referring to FIG. 2, the light guide plate 10 is first provided (step 1). The light guide plate 10 is made of polymer resin. Generally the light guide plate 10 is made of polymethyl methacrylate. The light guide plate 10 comprises top and bottom surfaces 14, 12. Two protective films 20 are respectively attached on the top and bottom surfaces 12, 14 of the light guide plate 10 before processing of the light guide plate 10 (step 2). Generally, the protective films 20 are made of plastic to isolate the top and bottom surfaces of the light guide plate 10 from moisture in the air, and furthermore, to prevent the light guide plate 10 from becoming distorted due to moisture absorption.

Referring to FIG. 3, the protective films 20 have been removed for processing of the light guide plate 10. The protective films 20 is removed from the surfaces 12, 14 immediately before processing of the light guide plate 10 (step 3). A polymer coating 30 is formed on one of the surfaces 12, 14 which is not to be processed after removing the protective films 20 (step 4). The polymer coating 30 is formed on the surface 12 or 14 by spraying or using other suitable methods. The polymer coating must be formed on the surface 12 or 14 before further steps of processing. The polymer coating 30 has two sides (not labeled). One side of the polymer coating 30 which is adjacent the not-to-be processed surface 12 or 14, is lipophilic so that it easily attaches to the light guide plate 10, which is made of polymethyl methacrylate. The opposite side of the polymer coating 30 is hydrophobic, so that it isolates the light guide plate 10 from moisture in the air. Functional groups in the polymer coating 30 can only absorb wavelengths longer than 780 nanometers or shorter than 380 nanometers, so that the polymer coating does not affect the optical characteristics of the light guide plate 10.

It is understood that the invention may be embodied in other forms without departing from the spirit thereof. Thus, the present examples and embodiments are to be considered in all respects as illustrative and not restrictive, and the invention is not to be limited to the details given herein.

1. A method for preventing a light guide plate from being distorted comprising the following steps:
providing a light guide plate comprising two surfaces;
attaching protective films on the two surfaces of the light guide plate before processing the light guide plate;
removing the films from the two surfaces immediately before processing; and
forming a polymer coating on one of the surfaces of the light guide plate which is not to be processed after removing the films, the polymer coating being formed on the surface before further steps of processing.

2. The method as described in claim 1, wherein the polymer coating has two sides, one side being hydrophobic, and the opposite side being lipophilic.

3. The method as described in claim 2, wherein the lipophilic side of the polymer coating is adjacent the light guide plate.

4. The method as described in claim 1, wherein the protective films are made of plastic materials.

5. The method as described in claim 1, wherein functional groups in the polymer coating can only absorb wavelengths longer than 780 nanometers or shorter than 380 nanometers.

6. The method as described in claim 1, wherein the light guide plate is made of polymethyl methacrylate.

7. The method as described in claim 1, wherein the polymer coating is formed on the surface of the light guide plate by spraying or by other suitable methods.

8. A structure including a light guide plate providing a processing surface, and a non-processing surface located opposite to said processing surface and coated with a polymer coating which defines two sides of which, one relatively adjacent to the non-processing surface is lipophilic for good attachment on the light guide plate, and the other relatively away from the non-processing surface is hydrophobic for good isolation from moisture in the air.
